(19) United States
(12) Patent Application Publication
(10) Pub. No.: US 2024/0248467 A1
(43) Pub. Date: Jul. 25, 2024

(54) AUTOMATIC ONLINE FLARING DATA VALIDATION AND REPORTING

(71) Applicant: Saudi Arabian Oil Company, Dhahran (SA)

(72) Inventors: Saeed Mohammed Alamoudi, Ras Tanura (SA); Mohamed Ahmed Soliman, Ontario (CA); Hassan Mohammadali Al Matouq, Al Qatif (SA)

(21) Appl. No.: 18/157,541

(22) Filed: Jan. 20, 2023

(51) Int. Cl. G05B 23/02; G06Q 10/20; G06T 7/00

(52) U.S. Cl. CPC G05B 23/0275; G05B 23/0254; G06Q 10/20; G06T 7/0004

(57) ABSTRACT

A computer-implemented method and system for validating physical flare flowmeter readings using virtual flare flowmeter predictions can include receiving physical gas flare flow measurement data from a physical flare flowmeter coupled upstream from a flare stack; receiving predicted gas flare flow measurement data from a virtual flare flowmeter; determining a quantitative deviation value between the physical gas flare flow measurement data and the predicted gas flare flow measurement data; and for quantitative deviation values less than a threshold deviation value, determining that the physical gas flare flow measurement data is accurate. The method and system can automatically identify abnormalities in any of physical flow meter (PFF) and virtual flow meter (VFF) and automatically select the accurate reading between the PFF and VFF to be used based on online plant and equipment conditions as inputs.

### FIELD

This disclosure pertains to automatic online flaring data validation and reporting.

### BACKGROUND

Gas flaring from a flare stack is a gas combustion byproduct occurring from processes used in industrial plants and oil and gas extraction sites. In industrial plants, flare stacks are primarily used for burning off flammable gas released by safety valves during unplanned over-pressuring of plant equipment. During plant or partial plant startups and shutdowns, flare stacks are also used for the planned combustion of gases over relatively short periods. At oil and gas extraction sites, gas flares are similarly used for a variety of startup, maintenance, testing, safety, and emergency purposes. In production flaring, gas flares may also be used to dispose of large amounts of unwanted associated petroleum gas.

### SUMMARY

The present disclosure describes techniques that can be used for automatic online flaring data validation and reporting. Physical Flare Flowmeters (PFF) are subject to frequent malfunction and inaccuracy resulting in the use of incorrect figures to report these critical readings. This disclosure describes a method to validate these meters' readings using machine learning (ML) based Virtual Flare Flowmeter (VFF). Moreover, this disclosure describes a system that can automatically identify abnormalities in any of PFF and VFF and automatically select the accurate reading between the PFF and VFF to be used based on online plant and equipment conditions as inputs.

In some implementations, a computer-implemented method includes the following.

Aspects of the embodiments are directed to a computer-implemented method for validating physical flare flowmeter readings using virtual flare flowmeter predictions, the method including receiving physical gas flare flow measurement data from a physical flare flowmeter coupled upstream from a flare stack; receiving predicted gas flare flow measurement data from a virtual flare flowmeter; determining a quantitative deviation value between the physical gas flare flow measurement data and the predicted gas flare flow measurement data; and for quantitative deviation values less than a threshold deviation value, determining that the physical gas flare flow measurement data is accurate.

Some embodiments include updating one or more machine learning models associated with the virtual flare flowmeter using the physical gas flare flow measurement data.

Some embodiments include, for quantitative deviation values greater than or equal to the threshold deviation value: receiving a first image set of a gas flare from a first time period from an imaging device; receiving a second image set of the gas flare from a second time period earlier than the first time period; comparing the first image set and the second image set; determining, from comparing the first image set and the second image set, a magnitude of change between the first image set and the second image set. For a magnitude of change between the first image set and the second image set greater than or equal to a threshold image deviation magnitude, the method can include determining that the imaging device is faulty, and issuing a maintenance ticket for the virtual flare flowmeter.

Some embodiments include, for a magnitude of change between the first image set and the second image set less than a threshold image deviation magnitude: evaluating an operating condition associated with operation of the flare stack; determining whether a change in an operating condition associated with operation of the flare stack correlates with the physical gas flare flow measurement data; and if no correlation exists between the change in the operation condition and the physical gas flare flow measurement data, determining that the physical flare flowmeter is faulty and validating the predicted gas flare flow measurement data from a virtual flare flowmeter. If a correlation exists between the change in the operation condition and the physical gas flare flow measurement data, issuing a ticket for manual analysis to determine the root cause of deviation between PFF and VFF.

In some embodiments, the operating condition includes one or more of a change in emergency shutdown signaling, pressure relief system status, pressure readings upstream from the physical flare flowmeter, pressure readings downstream of the physical flare flowmeter, temperature readings upstream from the physical flare flowmeter, and temperature readings downstream of the physical flare flowmeter.

Aspects of the embodiments are directed to a non-transitory, computer-readable storage medium storing instructions for validating data from a physical flare flowmeter and data from a virtual flare flowmeter, the instructions, when executed by a hardware processor, cause the hardware process to perform operations including receiving physical gas flare flow measurement data from a physical flare flowmeter coupled upstream from a flare stack; receiving predicted gas flare flow measurement data from a virtual flare flowmeter; determining a quantitative deviation value between the physical gas flare flow measurement data and the predicted gas flare flow measurement data; and for quantitative deviation values less than a threshold deviation value, determining that the physical gas flare flow measurement data is accurate.

Some embodiments include updating one or more machine learning models associated with the virtual flare flowmeter using the physical gas flare flow measurement data.

Some embodiments include, for quantitative deviation values greater than or equal to the threshold deviation value: receiving a first image set of a gas flare from a first time period from an imaging device; receiving a second image set of the gas flare from a second time period earlier than the first time period; comparing the first image set and the second image set; determining, from comparing the first image set and the second image set, a magnitude of change between the first image set and the second image set. For a magnitude of change between the first image set and the second image set greater than or equal to a threshold image deviation magnitude: determining that the imaging device is faulty, and issuing a maintenance ticket for the virtual flare flowmeter.

Some embodiments include, for a magnitude of change between the first image set and the second image set less than a threshold image deviation magnitude: evaluating an operating condition associated with operation of the flare stack; determining whether a change in an operating condition associated with operation of the flare stack correlates with the physical gas flare flow measurement data; and if no correlation exists between the change in the operation condition and the physical gas flare flow measurement data, determining that the physical flare flowmeter is faulty and validating the predicted gas flare flow measurement data from a virtual flare flowmeter, and if a correlation exists between the change in the operation condition and the physical gas flare flow measurement data, issuing a ticket for manual analysis to identify the cause of the physical gas flare flow fault condition.

In some embodiments, the operating condition includes one or more of a change in emergency shutdown signaling, pressure relief system status, pressure readings upstream from the physical flare flowmeter, pressure readings downstream of the physical flare flowmeter, temperature readings upstream from the physical flare flowmeter, and temperature readings downstream of the physical flare flowmeter.

Aspects of the embodiments are directed to a computer-implemented system for validating data from a physical flare flowmeter and a virtual flare flowmeter, the system including one or more processors; and one or more computer memories connected to communicate with the one or more processors and storing instructions and flare flowmeter analysis logic, that when executed by the one or more processors, cause the system to perform operations, the operations can include receiving physical gas flare flow measurement data from a physical flare flowmeter coupled upstream from a flare stack; receiving predicted gas flare flow measurement data from a virtual flare flowmeter; determining a quantitative deviation value between the physical gas flare flow measurement data and the predicted gas flare flow measurement data; and for quantitative deviation values less than a threshold deviation value, determining that the physical gas flare flow measurement data is accurate.

Some embodiments include updating one or more machine learning models associated with the virtual flare flowmeter using the physical gas flare flow measurement data.

Some embodiments include, for quantitative deviation values greater than or equal to the threshold deviation value: receiving a first image set of a gas flare from a first time period from an imaging device; receiving a second image set of the gas flare from a second time period earlier than the first time period; comparing the first image set and the second image set; determining, from comparing the first image set and the second image set, a magnitude of change between the first image set and the second image set; and for a magnitude of change between the first image set and the second image set greater than or equal to a threshold image deviation magnitude: determining that the imaging device is faulty, and issuing a maintenance ticket for the virtual flare flowmeter.

Some embodiments include, for a magnitude of change between the first image set and the second image set less than a threshold image deviation magnitude: evaluating an operating condition associated with operation of the flare stack; determining whether a change in an operating condition associated with operation of the flare stack correlates with the physical gas flare flow measurement data; and if no correlation exists between the change in the operation condition and the physical gas flare flow measurement data, determining that the physical flare flowmeter is faulty and validating the predicted gas flare flow measurement data from a virtual flare flowmeter. If a correlation exists between the change in the operation condition and the physical gas flare flow measurement data, issuing a ticket for manual analysis to determine the root cause of deviation between PFF and VFF.

In some embodiments, the operating condition includes one or more of a change in emergency shutdown signaling, pressure relief system status, pressure readings upstream from the physical flare flowmeter, pressure readings downstream of the physical flare flowmeter, temperature readings upstream from the physical flare flowmeter, and temperature readings downstream of the physical flare flowmeter.

Some embodiments include a data connection to a physical flare flowmeter coupled upstream of a flare stack, the physical flare flowmeter to measure flow rate of gas entering the flare stack and provide the flow rate of the gas to the flare flowmeter analysis logic.

In some embodiments, the one or more computer memories including virtual flare flowmeter logic to predict gas flowrate and volume through a flare stack based, at least in part, on a set of images of fire, smoke, or a combination of fire and smoke emitted from the flare stack.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this specification can be implemented in particular implementations, so as to realize one or more of the following advantages. Aspects of this disclosure provide for accurate flare gas flow measurements using either virtual flare flowmeter data or physical flare flowmeter data, and can be used to validate virtual flare flowmeter data. Validation of virtual flare flowmeter data can also improve underlying prediction models.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### BRIEF DESCRIPTION OF THE DRAWINGS

FIG. 1 is a schematic diagram of an example flare flow measurement system in accordance with embodiments of the present disclosure.

FIG. 2 is a schematic diagram of example virtual flare flowmeter logic in accordance with embodiments of the present disclosure.

FIG. 3 is a process flow diagram 300 for validating virtual flare flowmeter data and physical flare flowmeter data in accordance with embodiments of the present disclosure.

FIG. 4 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for validating both virtual and physical flare flowmeter data. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

Physical Flare Flowmeters (PFF) are subject to frequent malfunction and inaccuracy resulting in the use of incorrect figures to report critical readings. This disclosure describes systems and methods to validate PFF readings using machine learning (ML) based Virtual Flare Flowmeter (VFF) predictions. Moreover, this disclosure describes a system that will automatically identify abnormalities in any of PFF and VFF and can automatically select the accurate reading to be used on online plant and equipment conditions as inputs.

This disclosure provides systems and methods that can validate both physical and virtual flare flowmeters. The validation process can synergize data from virtual sensors, physical sensors, and plant data to accurately estimate the gas flaring.

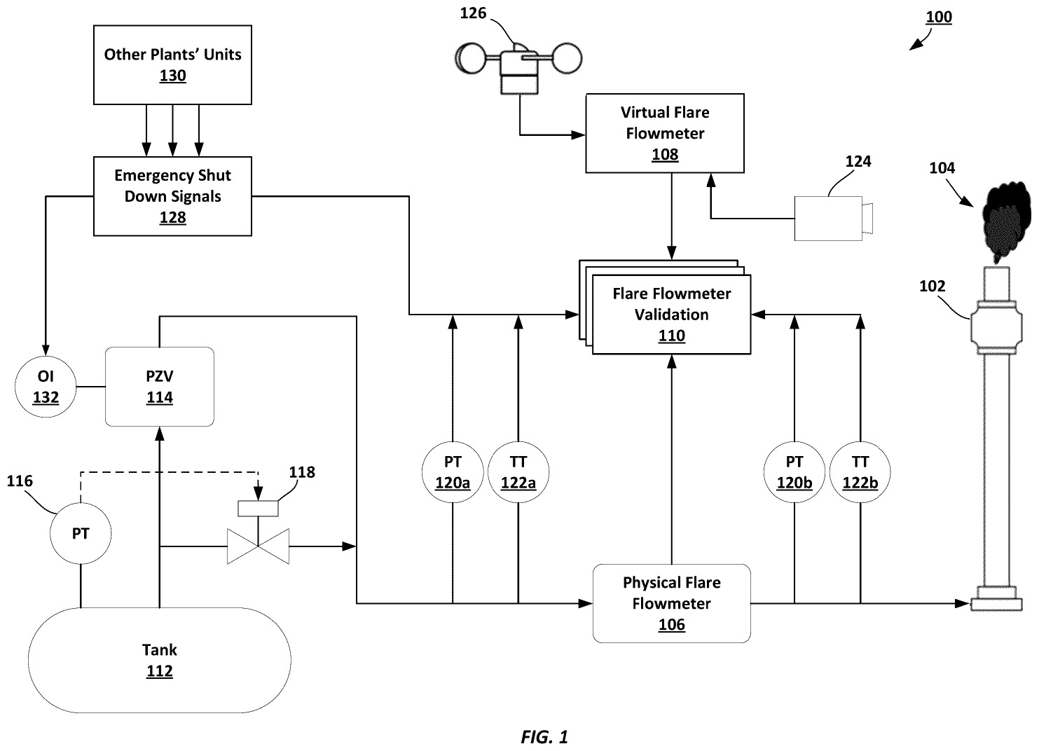

FIG. 1 is a schematic diagram of an example flare flow measurement system 100 in accordance with embodiments of the present disclosure. The example flare flow measurement system 100 can be part of an industrial plant, which can include a refinery, a processing plant, an oil and gas extraction site, or other type of industrial plant where flare stacks are used to burn flammable, volatile, or other potentially harmful fluids. The flare stack 102 can include a fluid combustion device to burn off flammable fluids. The flare stack 102 can use a pilot flame tip and an ignition spark to ignite flammable gas, for example, from tank 112. Tank 112 can hold liquid, such as oil or other process liquids. The tank can also hold gaseous fluids. The tank 112 is connected to pneumatic closure valve (PZV) 114 and a bypass valve 118. The bypass valve 118 can be operated based on gas pressure information from the tank 112 received from pressure transmitter 116. Pressure transmitter 116 can include a pressure gauge and circuitry or other logic to transmit pressure information about the tank 112 to bypass valve 118, so as to control opening or closing of the bypass valve 118.

In either case, gas from the tank 112 can enter the physical flare flowmeter (PFF) 106, which can determine flowrate of gas or other fluids from tank 112. The gas can then be burned off by flare stack 102 (shown as flame 104). Data from the PFF 106 can be used as inputs to various components of the industrial plant, such as controls for plant operating and safety conditions.

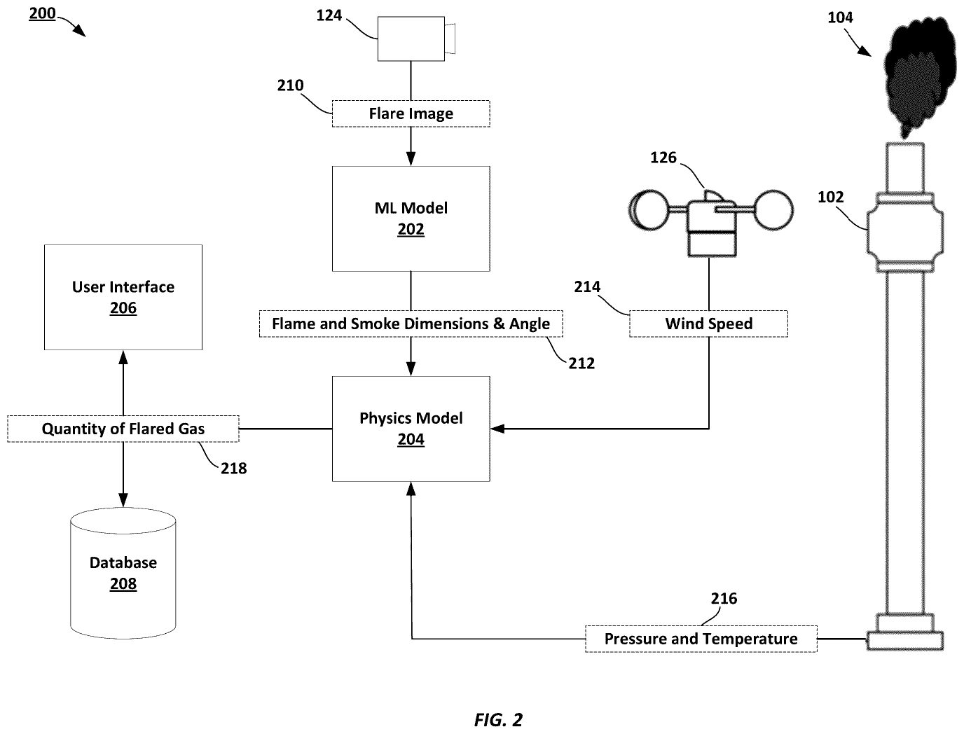

A virtual flare flowmeter 108 can be used to predict gas flow using information received from sensors and other inputs that indicate conditions of the plant. For example, the virtual flare flowmeter can receive image data from an image sensor 124. Image sensor 124 can be a camera, CCTV imager, thermal imager, or other type of imager that can provide image data of the fire and smoke from the flare stack 102. In addition, the VFF 108 can use wind speed data from a wind speed sensor 126 to process the image data. The image data can be used to determine flare fire and smoke parameters including flame length and angle. The VFF 108 is shown in more detail in FIG. 2.

FIG. 2 is a schematic diagram of example virtual flare flowmeter logic 200 in accordance with embodiments of the present disclosure. The VFF logic 200 can be the same or similar as that used by VFF 108 in FIG. 1. VFF logic 200 can include a combination of machine learning models 202 and mathematical and physics models 204 to monitor gas flaring. The VFF can detect fire and smoke in flaring images 210 from streaming images or video coming from an imaging device 124 (e.g., CCTV camera) that is fed into the machine learning model 202. The VFF 200 can determine various aspects of the fire, smoke, or both with a high degree of precision from the flare images 210. The detected aspects and dimensions of the fire and smoke can be calibrated to the real units, such as feet or meters for height and width, by using a scaling factor. For example, the dimensions and angle 212 of the fire and smoke can be determined (or predicted) by the machine learning models 202. The predicted parameters of fire and smoke 212 from the machine learning models 202 can be used as an input to the physics model 204. Other inputs can also be fed into the physical model 204, such as the gas pressure and temperature 216, the stack type, and environmental variables, such as wind speed 214 from wind speed sensor 126. The physics model 204 can use these inputs (among others) to predict the volume of flared gas from the flare stack.

The machine learning model 202 can include a deep-learning model, which can be based on Convolutional Neural Network to detect fire and smoke from one or more given images. A CNN model can geometrically calculate the various parameters like length, area, centroid for the flare. Based on a scaling factor, the pixel values from the images are also converted to a unit, such as feet or meters, based on preferences. Flowrate is then calculated using a physics model, such as an API-521 physics model. The physics model 204 uses physical values, such as wind-speed, fire length, stack characteristics, and headgear pressure and temperature values to calculate the gas volume 218 being burned through the stacks.

The quantity of flared gas 218 can be stored in a database 208, along with the parameters used to determine the quantity of flared gas 218. The quantity of flared gas 218 can also be displayed on a user interface 206 (again, with the parameters used to determine the quantity of flared gas 218). By storing the predicted quantity of flared gas 218 with the parameters used to determine the volume, the predicted quantity of flared gas 218 can be checked manually if a deviation occurs or other problems arise with the predictions. For example, if it is found that the physical flare flowmeter values are correct but deviate from the predicted values, then the predicted values along with various VFF algorithms and models can be evaluated for errors using the parameters used to derive the predicted values.

Returning to FIG. 1, a flare flowmeter validation logic 110 can be used to validate data from the PFF 106 and the VFF 108. The flare flowmeter validation logic 110 can include hardware and software or both to perform operations, including the evaluation of PFF data and VFF data.

The flare flowmeter validation logic 110 can receive PFF data from PFF 106, VFF predicted data from VFF 108, as well as information from other sources. For example, gas pressure information upstream from the PFF 106 can be provided to the flare flowmeter validation logic 110 via an upstream pressure transmitter 120a. Gas pressure information downstream from the PFF 106 can be provided to the flare flowmeter validation logic 110 via a downstream pressure transmitter 120b. The upstream and downstream pressure transmitters 120a and 120b can include circuitry and/or software to read pressure information and transmit pressure information to a computing device that operates the flare flowmeter validation logic 110 (e.g., computing device 402). Gas temperature information upstream from the PFF 106 can be provided to the flare flowmeter validation logic 110 via an upstream temperature transmitter 122a. Gas temperature information downstream from the PFF 106 can be provided to the flare flowmeter validation logic 110 via a downstream temperature transmitter 122b. The upstream and downstream temperature transmitters 122a and 122b can include circuitry and/or software to read pressure information and transmit temperature information to a computing device that operates the flare flowmeter validation logic 110 (e.g., computing device 402).

Other sources of validation data can come from emergency shutdown (ESD) signals 128. ESD signals 128 can be signals representing emergency shutdown scenarios from the current plant unit or from other plant units 130. (The ESD signals 128 can also control an opening indicator 132 for controlling the pneumatic closure value during a shutdown or after the shutdown is resolved.)

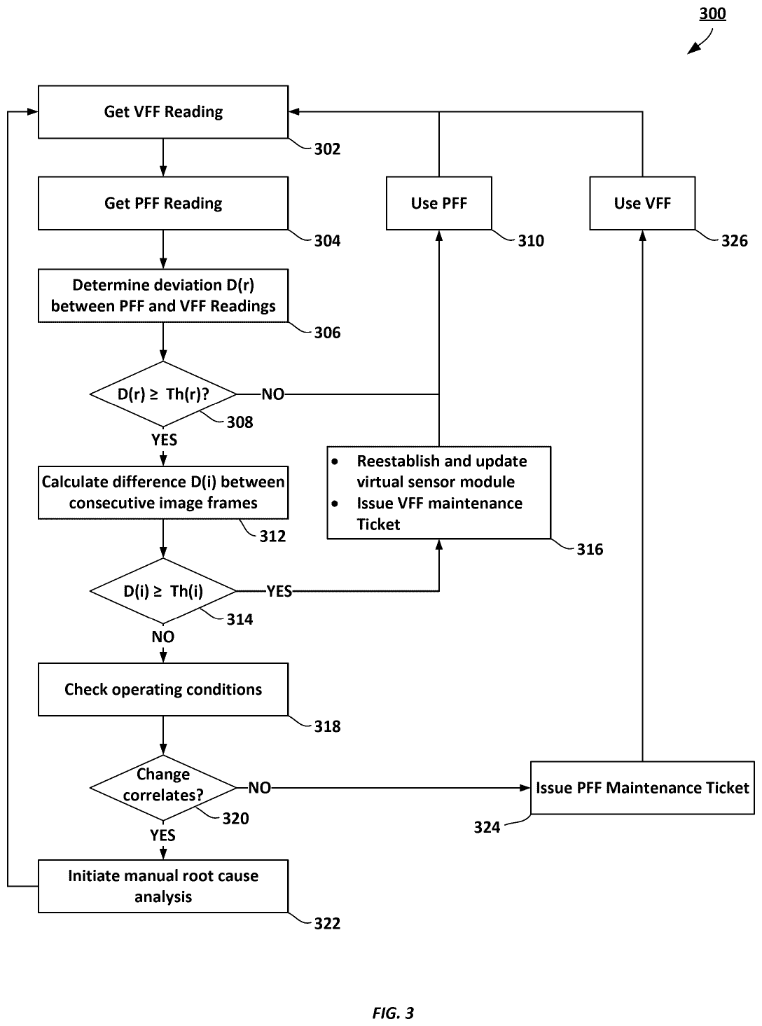

FIG. 3 is a process flow diagram 300 for validating virtual flare flowmeter data and physical flare flowmeter data in accordance with embodiments of the present disclosure. While a flare stack is operating to flare a gas, the PFF and the VFF operate to determine flowrate and gas volume. As an on-going process, for VFF calculations, the flare flowmeter validation logic can automatically validate, identify, and report accurate readings. The flare flowmeter validation logic receives readings from VFF (302) and getting readings from PFF (304). Though shown as successive steps, getting readings from VFF and PFF can occur in any order or at the same time. That is, PFF and VFF readings can be provided to the algorithm in real-time or buffered for later processing. Next, absolute value of percentage deviation value (Dr) is calculated between these two readings (306). If, at (308), D(r) is found to be less than a threshold deviation value (e.g., Th(r)=10% deviation), the flare flowmeter validation logic will conclude validity of PFF and use that reading as the accurate one (310). Otherwise, at (308), if D(r) is found to be greater than or equal to the threshold deviation value Th(r), the flare flowmeter validation logic can conclude that validation is failed and further analysis of VFF and PFF is needed to determine more reliable one.

The flare flowmeter validation logic can begin the failure analysis by studying the status of VFF readings to ensure that it is not malfunctioning by calculating the difference between one or more current image frames and one or more previous image frames to find magnitude of change (312). For example, a set of image frames I(p) can be compared against an older set of image frames I(p−n), where p represents a period of a predetermined amount of time and n≥1; the output of the comparison is an image deviation value D(i). In embodiments, the image deviation D(i) is a sum or weighted sum of absolute differences of some or all pixel values from two or more successive frames. The sum or weighted sum is used to represent a magnitude of the deviation between two frames. D(i) can be determined continuously or as-needed between two or more frames to determine deviations.

If, at (314), the deviation D(i) is greater than or equal to a threshold image deviation value (e.g., 30% deviation), the flare flowmeter validation logic will conclude a faulty CCTV camera feed and VFF reading to be recognized as inaccurate (316). This conclusion is accurate due to the fact that CCTV camera is fixed toward the flare stack with fixed background pixel values for majority of frame pixels. As a result, the flare flowmeter validation logic can initiate a maintenance ticket for VFF (316). The flare flowmeter validation logic can also cause a reestablishment and update of the virtual sensor module as part of the maintenance of the VFF (316). The PFF values are used as inputs for operating conditions (310). Flare occurs as a response to changes in plant and equipment condition. These changes will be used as an input in the validation process. If, at (312), the deviation D(i) is less than the threshold Th(i), the flare flowmeter validation logic can analyze PFF reading by checking flaring-related plant operating conditions such as changes in ESD signals, pressure relief system status, pressure and temperature readings upstream and downstream flowmeter (318). Then the flare flowmeter validation logic can analyze if the change in PFF readings was backed with a change in plant operating conditions (318). If, at (320), the PFF readings are not supported or caused by one or more changes in plant operating conditions, the flare flowmeter validation logic will conclude malfunctioning PFF and will report VFF as the accurate reading by issuing a maintenance ticket for manual analysis to determine the root cause of deviation between PFF and VFF (324). The VFF prediction data will be used (326). Otherwise, at (320), if the PFF readings correlate to one or more changes in the plant's operating conditions, the flare flowmeter validation logic can raise a notification for the need to conduct manual deviation root cause analysis (322). The deviation analysis described above can cause the system to automatically select one of PFF or VFF.

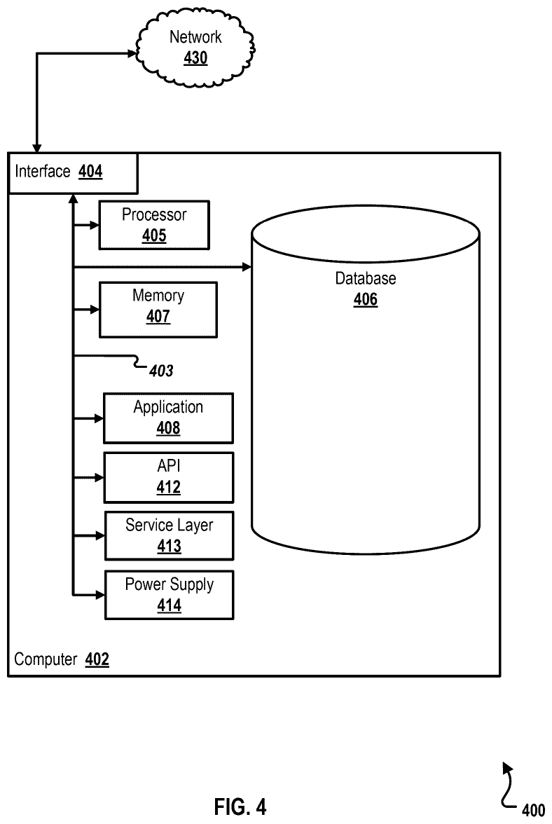

FIG. 4 is a block diagram illustrating an example computer system used to provide computational functionalities associated with described algorithms, methods, functions, processes, flows, and procedures as described in the present disclosure, according to some implementations of the present disclosure. FIG. 4 is a block diagram of an example computer system 400 used to provide computational functionalities associated with described algorithms, methods, functions, processes, flows, and procedures described in the present disclosure, according to some implementations of the present disclosure. The illustrated computer 402 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 402 can include input devices such as keypads, keyboards, and touch screens that can accept user information. Also, the computer 402 can include output devices that can convey information associated with the operation of the computer 402. The information can include digital data, visual data, audio information, or a combination of information. The information can be presented in a graphical user interface (UI) (or GUI).

The computer 402 can serve in a role as a client, a network component, a server, a database, a persistency, or components of a computer system for performing the subject matter described in the present disclosure. The illustrated computer 402 is communicably coupled with a network 430. In some implementations, one or more components of the computer 402 can be configured to operate within different environments, including cloud-computing-based environments, local environments, global environments, and combinations of environments.

At a top level, the computer 402 is an electronic computing device operable to receive, transmit, process, store, and manage data and information associated with the described subject matter. According to some implementations, the computer 402 can also include, or be communicably coupled with, an application server, an email server, a web server, a caching server, a streaming data server, or a combination of servers.

The computer 402 can receive requests over network 430 from a client application (for example, executing on another computer 402). The computer 402 can respond to the received requests by processing the received requests using software applications. Requests can also be sent to the computer 402 from internal users (for example, from a command console), external (or third) parties, automated applications, entities, individuals, systems, and computers.

Each of the components of the computer 402 can communicate using a system bus 403. In some implementations, any or all of the components of the computer 402, including hardware or software components, can interface with each other or the interface 404 (or a combination of both) over the system bus 403. Interfaces can use an application programming interface (API) 412, a service layer 413, or a combination of the API 412 and service layer 413. The API 412 can include specifications for routines, data structures, and object classes. The API 412 can be either computer-language independent or dependent. The API 412 can refer to a complete interface, a single function, or a set of APIs.

The service layer 413 can provide software services to the computer 402 and other components (whether illustrated or not) that are communicably coupled to the computer 402. The functionality of the computer 402 can be accessible for all service consumers using this service layer. Software services, such as those provided by the service layer 413, can provide reusable, defined functionalities through a defined interface. For example, the interface can be software written in JAVA, C++, or a language providing data in extensible markup language (XML) format. While illustrated as an integrated component of the computer 402, in alternative implementations, the API 412 or the service layer 413 can be stand-alone components in relation to other components of the computer 402 and other components communicably coupled to the computer 402. Moreover, any or all parts of the API 412 or the service layer 413 can be implemented as child or sub-modules of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402 and the described functionality. The interface 404 can be used by the computer 402 for communicating with other systems that are connected to the network 430 (whether illustrated or not) in a distributed environment. Generally, the interface 404 can include, or be implemented using, logic encoded in software or hardware (or a combination of software and hardware) operable to communicate with the network 430. More specifically, the interface 404 can include software supporting one or more communication protocols associated with communications. As such, the network 430 or the interface's hardware can be operable to communicate physical signals within and outside of the illustrated computer 402.

The computer 402 includes a processor 405. Although illustrated as a single processor 405 in FIG. 4, two or more processors 405 can be used according to particular needs, desires, or particular implementations of the computer 402 and the described functionality. Generally, the processor 405 can execute instructions and can manipulate data to perform the operations of the computer 402, including operations using algorithms, methods, functions, processes, flows, and procedures as described in the present disclosure.

The computer 402 also includes a database 406 that can hold data for the computer 402 and other components connected to the network 430 (whether illustrated or not). For example, database 406 can be an in-memory, conventional, or a database storing data consistent with the present disclosure. In some implementations, database 406 can be a combination of two or more different database types (for example, hybrid in-memory and conventional databases) according to particular needs, desires, or particular implementations of the computer 402 and the described functionality. Although illustrated as a single database 406 in FIG. 4, two or more databases (of the same, different, or combination of types) can be used according to particular needs, desires, or particular implementations of the computer 402 and the described functionality. While database 406 is illustrated as an internal component of the computer 402, in alternative implementations, database 406 can be external to the computer 402.

The computer 402 also includes a memory 407 that can hold data for the computer 402 or a combination of components connected to the network 430 (whether illustrated or not). Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 (of the same, different, or combination of types) can be used according to particular needs, desires, or particular implementations of the computer 402 and the described functionality. While memory 407 is illustrated as an internal component of the computer 402, in alternative implementations, memory 407 can be external to the computer 402.

The application 408 can be an algorithmic software engine providing functionality according to particular needs, desires, or particular implementations of the computer 402 and the described functionality. For example, application 408 can serve as one or more components, modules, or applications. Further, although illustrated as a single application 408, the application 408 can be implemented as multiple applications 408 on the computer 402. In addition, although illustrated as internal to the computer 402, in alternative implementations, the application 408 can be external to the computer 402.

The computer 402 can also include a power supply 414. The power supply 414 can include a rechargeable or non-rechargeable battery that can be configured to be either user-or non-user-replaceable. In some implementations, the power supply 414 can include power-conversion and management circuits, including recharging, standby, and power management functionalities. In some implementations, the power-supply 414 can include a power plug to allow the computer 402 to be plugged into a wall socket or a power source to, for example, power the computer 402 or recharge a rechargeable battery.

There can be any number of computers 402 associated with, or external to, a computer system containing computer 402, with each computer 402 communicating over network 430. Further, the terms “client,” “user,” and other appropriate terminology can be used interchangeably, as appropriate, without departing from the scope of the present disclosure. Moreover, the present disclosure contemplates that many users can use one computer 402 and one user can use multiple computers 402.

Described implementations of the subject matter can include one or more features, alone or in combination.

Example 1 is a computer-implemented method for validating physical flare flowmeter readings using virtual flare flowmeter predictions, the method including receiving physical gas flare flow measurement data from a physical flare flowmeter coupled upstream from a flare stack; receiving predicted gas flare flow measurement data from a virtual flare flowmeter; determining a quantitative deviation value between the physical gas flare flow measurement data and the predicted gas flare flow measurement data; and for quantitative deviation values less than a threshold deviation value, determining that the physical gas flare flow measurement data is accurate.

Example 2 may include the subject matter of example 1, and can also include updating one or more machine learning models associated with the virtual flare flowmeter using the physical gas flare flow measurement data.

Example 3 may include the subject matter of any of examples 1-2, and can also include, for quantitative deviation values greater than or equal to the threshold deviation value: receiving a first image set of a gas flare from a first time period from an imaging device; receiving a second image set of the gas flare from a second time period earlier than the first time period; comparing the first image set and the second image set; determining, from comparing the first image set and the second image set, a magnitude of change between the first image set and the second image set. For a magnitude of change between the first image set and the second image set greater than or equal to a threshold image deviation magnitude, the method can include determining that the imaging device is faulty, and issuing a maintenance ticket for the virtual flare flowmeter.

Example 4 may include the subject matter of example 3, and can also include, for a magnitude of change between the first image set and the second image set less than a threshold image deviation magnitude: evaluating an operating condition associated with operation of the flare stack; determining whether a change in an operating condition associated with operation of the flare stack correlates with the physical gas flare flow measurement data; and if no correlation exists between the change in the operation condition and the physical gas flare flow measurement data, determining that the physical flare flowmeter is faulty and validating the predicted gas flare flow measurement data from a virtual flare flowmeter. If a correlation exists between the change in the operation condition and the physical gas flare flow measurement data, issuing a ticket for manual analysis to determine the root cause of deviation between PFF and VFF.

Example 5 may include the subject matter of any of examples 1-4, and the operating condition includes one or more of a change in emergency shutdown signaling, pressure relief system status, pressure readings upstream from the physical flare flowmeter, pressure readings downstream of the physical flare flowmeter, temperature readings upstream from the physical flare flowmeter, and temperature readings downstream of the physical flare flowmeter.

Example 6 is a non-transitory, computer-readable storage medium storing instructions for validating data from a physical flare flowmeter and data from a virtual flare flowmeter, the instructions, when executed by a hardware processor, cause the hardware process to perform operations including receiving physical gas flare flow measurement data from a physical flare flowmeter coupled upstream from a flare stack; receiving predicted gas flare flow measurement data from a virtual flare flowmeter; determining a quantitative deviation value between the physical gas flare flow measurement data and the predicted gas flare flow measurement data; and for quantitative deviation values less than a threshold deviation value, determining that the physical gas flare flow measurement data is accurate.

Example 7 may include the subject matter of example 6 and also include updating one or more machine learning models associated with the virtual flare flowmeter using the physical gas flare flow measurement data.

Example 8 may include the subject matter of any of examples 6-7, and can also include, for quantitative deviation values greater than or equal to the threshold deviation value: receiving a first image set of a gas flare from a first time period from an imaging device; receiving a second image set of the gas flare from a second time period earlier than the first time period; comparing the first image set and the second image set; determining, from comparing the first image set and the second image set, a magnitude of change between the first image set and the second image set. For a magnitude of change between the first image set and the second image set greater than or equal to a threshold image deviation magnitude: determining that the imaging device is faulty, and issuing a maintenance ticket for the virtual flare flowmeter.

Example 9 may include the subject matter of example 8, and can also include, for a magnitude of change between the first image set and the second image set less than a threshold image deviation magnitude: evaluating an operating condition associated with operation of the flare stack; determining whether a change in an operating condition associated with operation of the flare stack correlates with the physical gas flare flow measurement data; and if no correlation exists between the change in the operation condition and the physical gas flare flow measurement data, determining that the physical flare flowmeter is faulty and validating the predicted gas flare flow measurement data from a virtual flare flowmeter, and if a correlation exists between the change in the operation condition and the physical gas flare flow measurement data, issuing a ticket for manual analysis to determine the root cause of deviation between PFF and VFF.

Example 10 may include the subject matter of any of examples 6-9, the operating condition can also include one or more of a change in emergency shutdown signaling, pressure relief system status, pressure readings upstream from the physical flare flowmeter, pressure readings downstream of the physical flare flowmeter, temperature readings upstream from the physical flare flowmeter, and temperature readings downstream of the physical flare flowmeter.

Example 11 is a computer-implemented system for validating data from a physical flare flowmeter and a virtual flare flowmeter, the system including one or more processors; and one or more computer memories connected to communicate with the one or more processors and storing instructions and flare flowmeter analysis logic, that when executed by the one or more processors, cause the system to perform operations, the operations can include receiving physical gas flare flow measurement data from a physical flare flowmeter coupled upstream from a flare stack; receiving predicted gas flare flow measurement data from a virtual flare flowmeter; determining a quantitative deviation value between the physical gas flare flow measurement data and the predicted gas flare flow measurement data; and for quantitative deviation values less than a threshold deviation value, determining that the physical gas flare flow measurement data is accurate.

Example 12 may include the subject matter of example 11 include updating one or more machine learning models associated with the virtual flare flowmeter using the physical gas flare flow measurement data.

Example 13 may include the subject matter of any of examples 11-12, and can also include, for quantitative deviation values greater than or equal to the threshold deviation value: receiving a first image set of a gas flare from a first time period from an imaging device; receiving a second image set of the gas flare from a second time period earlier than the first time period; comparing the first image set and the second image set; determining, from comparing the first image set and the second image set, a magnitude of change between the first image set and the second image set; and for a magnitude of change between the first image set and the second image set greater than or equal to a threshold image deviation magnitude: determining that the imaging device is faulty, and issuing a maintenance ticket for the virtual flare flowmeter.

Example 14 may include the subject matter of example 13, and can also include, for a magnitude of change between the first image set and the second image set less than a threshold image deviation magnitude: evaluating an operating condition associated with operation of the flare stack; determining whether a change in an operating condition associated with operation of the flare stack correlates with the physical gas flare flow measurement data; and if no correlation exists between the change in the operation condition and the physical gas flare flow measurement data, determining that the physical flare flowmeter is faulty and validating the predicted gas flare flow measurement data from a virtual flare flowmeter. If a correlation exists between the change in the operation condition and the physical gas flare flow measurement data, issuing a ticket for manual analysis to determine the root cause of deviation between PFF and VFF.

Example 15 may include the subject matter of any of examples 11-14, the operating condition can include one or more of a change in emergency shutdown signaling, pressure relief system status, pressure readings upstream from the physical flare flowmeter, pressure readings downstream of the physical flare flowmeter, temperature readings upstream from the physical flare flowmeter, and temperature readings downstream of the physical flare flowmeter.

Example 16 may include the subject matter of any of examples 11-15, and can also include a data connection to a physical flare flowmeter coupled upstream of a flare stack, the physical flare flowmeter to measure flow rate of gas entering the flare stack and provide the flow rate of the gas to the flare flowmeter analysis logic.

Example 17 may include the subject matter of any of examples 11-16, the one or more computer memories can include virtual flare flowmeter logic to predict gas flowrate and volume through a flare stack based, at least in part, on a set of images of fire, smoke, or a combination of fire and smoke emitted from the flare stack.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

1. A computer-implemented method for validating physical flare flowmeter readings using virtual flare flowmeter predictions, the method comprising:
receiving physical gas flare flow measurement data from a physical flare flowmeter coupled upstream from a flare stack;
receiving predicted gas flare flow measurement data from a virtual flare flowmeter;
determining a quantitative deviation value between the physical gas flare flow measurement data and the predicted gas flare flow measurement data; and
for quantitative deviation values less than a threshold deviation value, determining that the physical gas flare flow measurement data is accurate.

2. The computer-implemented method of claim 1, further comprising updating one or more machine learning models associated with the virtual flare flowmeter using the physical gas flare flow measurement data.

3. The computer-implemented method of claim 1, further comprising, for quantitative deviation values greater than or equal to the threshold deviation value:
receiving a first image set of a gas flare from a first time period from an imaging device;
receiving a second image set of the gas flare from a second time period earlier than the first time period;
comparing the first image set and the second image set;
determining, from comparing the first image set and the second image set, a magnitude of change between the first image set and the second image set; and
for a magnitude of change between the first image set and the second image set greater than or equal to a threshold image deviation magnitude:
determining that the imaging device is faulty, and
issuing a maintenance ticket for the virtual flare flowmeter.

4. The computer-implemented method of claim 3, further comprising, for a magnitude of change between the first image set and the second image set less than a threshold image deviation magnitude:
evaluating an operating condition associated with operation of the flare stack;
determining whether a change in an operating condition associated with operation of the flare stack correlates with the physical gas flare flow measurement data; and
if no correlation exists between the change in the operation condition and the physical gas flare flow measurement data, determining that the physical flare flowmeter is faulty and validating the predicted gas flare flow measurement data from a virtual flare flowmeter, and
if a correlation exists between the change in the operation condition and the physical gas flare flow measurement data, issuing a ticket for manual analysis to determine the root cause of deviation between PFF and VFF.

5. The computer-implemented method of claim 4, wherein the operating condition comprises one or more of a change in emergency shutdown signaling, pressure relief system status, pressure readings upstream from the physical flare flowmeter, pressure readings downstream of the physical flare flowmeter, temperature readings upstream from the physical flare flowmeter, and temperature readings downstream of the physical flare flowmeter.

6. A non-transitory, computer-readable storage medium storing instructions for validating data from a physical flare flowmeter and data from a virtual flare flowmeter, the instructions, when executed by a hardware processor, cause the hardware process to perform operations comprising:
receiving physical gas flare flow measurement data from a physical flare flowmeter coupled upstream from a flare stack;
receiving predicted gas flare flow measurement data from a virtual flare flowmeter;
determining a quantitative deviation value between the physical gas flare flow measurement data and the predicted gas flare flow measurement data; and
for quantitative deviation values less than a threshold deviation value, determining that the physical gas flare flow measurement data is accurate.

7. The non-transitory, computer-readable storage medium of claim 6, the operations further comprising updating one or more machine learning models associated with the virtual flare flowmeter using the physical gas flare flow measurement data.

8. The non-transitory, computer-readable storage medium of claim 6, the operations further comprising, for quantitative deviation values greater than or equal to the threshold deviation value:
receiving a first image set of a gas flare from a first time period from an imaging device;
receiving a second image set of the gas flare from a second time period earlier than the first time period;
comparing the first image set and the second image set;
determining, from comparing the first image set and the second image set, a magnitude of change between the first image set and the second image set; and
for a magnitude of change between the first image set and the second image set greater than or equal to a threshold image deviation magnitude:
determining that the imaging device is faulty, and
issuing a maintenance ticket for the virtual flare flowmeter.

9. The non-transitory, computer-readable storage medium of claim 8, the operations further comprising, for a magnitude of change between the first image set and the second image set less than a threshold image deviation magnitude:
evaluating an operating condition associated with operation of the flare stack;
determining whether a change in an operating condition associated with operation of the flare stack correlates with the physical gas flare flow measurement data; and
if no correlation exists between the change in the operation condition and the physical gas flare flow measurement data, determining that the physical flare flowmeter is faulty and validating the predicted gas flare flow measurement data from a virtual flare flowmeter, and
if a correlation exists between the change in the operation condition and the physical gas flare flow measurement data, issuing a ticket for manual analysis to determine the root cause of deviation between PFF and VFF.

10. The non-transitory, computer-readable storage medium of claim 6, wherein the operating condition comprises one or more of a change in emergency shutdown signaling, pressure relief system status, pressure readings upstream from the physical flare flowmeter, pressure readings downstream of the physical flare flowmeter, temperature readings upstream from the physical flare flowmeter, and temperature readings downstream of the physical flare flowmeter.

11. A computer-implemented system for validating data from a physical flare flowmeter and a virtual flare flowmeter, the system comprising:
one or more processors; and
one or more computer memories connected to communicate with the one or more processors and storing instructions and flare flowmeter analysis logic, that when executed by the one or more processors, cause the system to perform operations comprising:
receiving physical gas flare flow measurement data from a physical flare flowmeter coupled upstream from a flare stack;
receiving predicted gas flare flow measurement data from a virtual flare flowmeter;
determining a quantitative deviation value between the physical gas flare flow measurement data and the predicted gas flare flow measurement data; and
for quantitative deviation values less than a threshold deviation value, determining that the physical gas flare flow measurement data is accurate.

12. The computer-implemented system of claim 11, the operations further comprising updating one or more machine learning models associated with the virtual flare flowmeter using the physical gas flare flow measurement data.

13. The computer-implemented system of claim 11, the operations further comprising, for quantitative deviation values greater than or equal to the threshold deviation value:
receiving a first image set of a gas flare from a first time period from an imaging device;
receiving a second image set of the gas flare from a second time period earlier than the first time period;
comparing the first image set and the second image set;
determining, from comparing the first image set and the second image set, a magnitude of change between the first image set and the second image set; and
for a magnitude of change between the first image set and the second image set greater than or equal to a threshold image deviation magnitude:
determining that the imaging device is faulty, and
issuing a maintenance ticket for the virtual flare flowmeter.

14. The computer-implemented system of claim 13, the operations further comprising, for a magnitude of change between the first image set and the second image set less than a threshold image deviation magnitude:
evaluating an operating condition associated with operation of the flare stack;
determining whether a change in an operating condition associated with operation of the flare stack correlates with the physical gas flare flow measurement data; and
if no correlation exists between the change in the operation condition and the physical gas flare flow measurement data, determining that the physical flare flowmeter is faulty and validating the predicted gas flare flow measurement data from a virtual flare flowmeter, and
if a correlation exists between the change in the operation condition and the physical gas flare flow measurement data, issuing a ticket for manual analysis to determine the root cause of deviation between PFF and VFF.

15. The computer-implemented system of claim 14, wherein the operating condition comprises one or more of a change in emergency shutdown signaling, pressure relief system status, pressure readings upstream from the physical flare flowmeter, pressure readings downstream of the physical flare flowmeter, temperature readings upstream from the physical flare flowmeter, and temperature readings downstream of the physical flare flowmeter.

16. The computer-implemented system of claim 11, further comprising a data connection to a physical flare flowmeter coupled upstream of a flare stack, the physical flare flowmeter to measure flow rate of gas entering the flare stack and provide the flow rate of the gas to the flare flowmeter analysis logic.

17. The computer-implemented system of claim 11, wherein the one or more computer memories comprising virtual flare flowmeter logic to predict gas flowrate and volume through a flare stack based, at least in part, on a set of images of fire, smoke, or a combination of fire and smoke emitted from the flare stack.
